(19) United States
(12) Patent Application Publication
(10) Pub. No.: US 2009/0046559 A1
(43) Pub. Date: Feb. 19, 2009

(54) HOLOGRAPHIC INFORMATION STORAGE MEDIUM, AND METHOD AND APPARATUS FOR RECORDING/REPRODUCING HOLOGRAPHIC INFORMATION USING THE SAME

(75) Inventors: Taek-seong Jeong, Suwon-si (KR); Jae-cheol Bae, Suwon-si (KR); Moon-il Jung, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/186,738

(22) Filed: Aug. 6, 2008

(30) Foreign Application Priority Data
Aug. 13, 2007 (KR) 2007-81445
Dec. 13, 2007 (KR) 2007-129901

(51) Int. Cl. G11B 7/00

(52) U.S. Cl. 369/103

(57) ABSTRACT

A holographic storage medium includes a substrate; a cover layer to receive a first circular polarization beam having a first polarization direction and a second circular polarization beam having a second polarization direction orthogonal to the first polarization direction; a polarization beam splitting/reflective layer disposed between the substrate and the cover layer to reflect the first beam while maintaining the first polarization direction of the first beam, and to transmit the second beam; and a holographic recording layer disposed between the polarization beam splitting/reflective layer and the cover layer to record information as an interference pattern formed in the holographic layer by the first beam reflected by the polarization beam splitting/reflective layer and the second beam received by the cover layer.

### CROSS-REFERENCE TO RELATED APPLICATIONS

This application claims the benefit of Korean Patent Application Nos. 2007-81445 filed on Aug. 13, 2007, and 2007-129901 filed on Dec. 13, 2007, in the Korean Intellectual Property Office, the disclosures of which are incorporated herein by reference in their entirety.

### BACKGROUND OF THE INVENTION

1. Field of the Invention

Aspects of the invention relate to a holographic information storage medium and a method and apparatus for recording/reproducing holographic information using the holographic information storage medium, and more particularly to a single-sided type holographic information storage medium in which a signal beam and a reference beam enter through the same surface of the holographic information storage medium, and which reduces noise when information is reproduced, and a method and apparatus for recording/reproducing holographic information using the single-sided type holographic information storage medium.

2. Description of the Related Art

Recently, information storage technology using holograms has attracted much attention. An information storage method using holograms stores information in the form of an optical interference pattern in a polymer material or an inorganic crystal that is sensitive to light. The optical interference pattern is formed using two laser beams that interfere with each other to produce an interference pattern. That is, an interference pattern, formed when a reference beam and a signal beam traveling along different paths interfere with each other, causes a chemical or physical change in a photosensitive storage medium, thereby recording information. In order to reproduce the information from a recorded interference pattern, a reference beam for reproduction, similar to the reference beam for recording, is emitted onto the interference pattern recorded on the storage medium, and the interference pattern diffracts the reference beam to restore the signal beam reproduce the information.

Holographic information storing technology includes a volume holographic method that records/reproduces information in units of a page by using volume holography, and a micro-holographic method that records/reproduces information in units of a single bit by using micro-holography. The volume holographic method has an advantage in that a large amount of information can be processed at the same time. However, the volume holographic method has a disadvantage in that it is difficult to commercialize as an information storage device for general consumers because an optical system needs to be very precisely adjusted.

In the micro-holographic method, two focused light beams are made to interfere with each other at a focal point on a storage medium, and by moving this interference pattern in a plane of the storage medium, a plurality of interference patterns are recorded to form an information plane. By stacking a plurality of information planes in a holographic recording layer in a depth direction of the storage medium, information is recorded in a three-dimensional (3D) manner.

If a signal beam and a reference beam are separately incident on opposite surfaces of an information storage medium for recording information, optical systems for the signal beam and the reference beam must be separately provided on opposite sides of the information storage medium, thereby increasing the size of the entire optical system. In order to overcome this problem, a single-sided recording/reproducing method in which a signal beam and a reference beam are emitted onto the same surface of an information storage medium has been proposed. In this method, the signal beam and the reference beam are focused on a focal point in a holographic recording layer included in the information storage medium, and information is recorded in the form of an interference pattern formed at the focal point. The recorded information can be reproduced by emitting the reference beam to the holographic recording layer.

However, the single-sided recording/reproducing method has a disadvantage in terms of noise due to reflected light. In a conventional optical information recording/reproducing method, by increasing the distance between a holographic recording layer and a reflective layer and defocusing reflected light that is incident on a photodetector, noise can be removed. However, since the amplitude of a reproduction signal is very small due to the characteristics of a hologram, it is difficult to apply the method of removing noise to a holographic information storage medium by increasing the distance between the holographic recording layer and the reflective layer. The reflectivity, that is, the diffraction efficiency, of a hologram varies according to the thickness of the recorded hologram and the refractive index variation in the information storage medium in which the hologram is recorded. In this regard, when holograms are locally recorded, like in the case of micro holograms, the reflectivity of the micro holograms is very small. Generally, the refractive index variation of a photopolymer that is typically used to form a holographic recording layer is at most 0.01. In this case, the reflectivity of micro holograms is 1% or less when the micro holograms are recorded by an optical system having a numerical aperture of 0.85. In addition, when information is recorded in multiple information planes in order to increase a recording capacity, the reflectivity is further reduced. Generally, it is known to one skilled in the art that the reflectivity is inversely proportional to the square of the number of holographic recording layers. For example, when twenty or more holographic recording layers are used, the reflectivity is extremely small, being 0.01% or less. Due to the characteristics of a hologram, when the distance between the holographic recording layer and the reflective layer is reduced in order to reduce noise due to reflected light, an aberration between the signal beam and the reference beam that must be compensated for is increased. In addition, since an optical system is sensitive to tilt, it is difficult configure the optical system.

### SUMMARY OF THE INVENTION

According to aspects of the invention, a holographic information storage medium on which information has been recorded using a single-sided recording method, and a method of and an apparatus for recording information on and/or reproducing information from the holographic information storage medium, can prevent a signal quality from deteriorating due to noise due to reflected light that is generated when information recorded on the holographic information storage medium is reproduced.

According to an aspect of the invention, a holographic information storage medium includes a substrate; a cover layer to receive a first circular polarization beam having a first polarization direction and a second circular polarization beam having a second polarization direction orthogonal to the first polarization direction; a polarization beam splitting/reflective layer disposed between the substrate and the cover layer to reflect the first beam maintaining the first polarization direction of the first beam, and to transmit the second beam; and a holographic recording layer disposed between the polarization beam splitting/reflective layer and the cover layer to record information as an interference pattern formed by the first beam reflected by the polarization beam splitting/reflective layer and the second beam received by the cover layer.

According to an aspect of the invention, a holographic information recording/reproducing apparatus is provided for recording information on and/or reproducing information from a holographic information storage medium. The holographic information storage medium includes a substrate; a cover layer; a polarization beam splitting/reflective layer disposed between the substrate and the cover layer to reflect a first circular polarization beam having a first polarization direction while maintaining the first polarization direction of the first beam, and to transmit a second circular polarization beam having a second polarization direction orthogonal to the first polarization direction; and a holographic recording layer disposed between the polarization beam splitting/reflective layer and the cover layer. The apparatus includes an optical pickup to generate the first circular polarization beam having the first polarization direction and the second circular polarization beam having the second polarization direction orthogonal to the first polarization direction, and to emit the first beam and the second beam to be incident on the cover layer of the holographic information storage medium so that the first beam is reflected by the polarization beam splitting/reflective layer; the first beam reflected by the polarization beam splitting/reflective layer and the second beam incident on the cover layer form an interference pattern at a focal point in the holographic recording layer; and the holographic recording layer records information as the interference pattern at the focal point.

According to an aspect of the invention, a holographic information recording/reproducing apparatus is provided for recording information on and/or reproducing information from a holographic information storage medium. The holographic information storage medium includes a substrate; a cover layer; a polarization beam splitting/reflective layer disposed between the substrate and the cover layer to reflect a first circular polarization beam having a first polarization direction while maintaining the first polarization direction of the first beam, and to transmit a second circular polarization beam having a second polarization direction orthogonal to the first polarization direction; and a holographic recording layer disposed between the polarization beam splitting/reflective layer and the cover layer to record information as an interference pattern formed at a focal point in the holographic recording layer by the first beam reflected by the polarization beam splitting/reflective layer and the second beam. The apparatus includes an optical pickup to generate the second circular polarization beam having the second polarization direction orthogonal to the first polarization direction, and to emit the second beam to be incident on the cover layer of the holographic information medium to that the second beam having the second polarization direction is partially reflected at the focal point by the interference pattern in the holographic recording layer to form a reflective beam having the first polarization, and is partially transmitted by the interference pattern in the holographic recording layer to form a transmissive beam having the second polarization direction; the reflective beam is incident on the optical pickup; the transmissive beam passes through the polarization beam splitting/reflective layer; and the polarization beam splitting/reflective layer blocks any reflected light generated by reflection of the transmissive beam after the transmissive beam has passed through the polarization beam splitting/reflective layer from being incident on the optical pickup.

According to an aspect of the invention, a method of recording information on and/or reproducing information from a holographic information storage medium is provided. The holographic information storage medium includes a substrate; a cover layer; a polarization beam splitting/reflective layer disposed between the substrate and the cover layer to reflect a first circular polarization beam having a first polarization direction while maintaining the first polarization direction of the first beam, and to transmit a second circular polarization beam having a second polarization direction orthogonal to the first polarization direction; and a holographic recording layer disposed between the polarization beam splitting/reflective layer and the cover layer. The method includes generating the first circular polarization beam having the first polarization direction and the second circular polarization beam having the second polarization direction orthogonal to the first polarization direction; emitting the first beam and the second beam onto the cover layer of the holographic information storage medium so that the first beam and the second beam pass through the cover layer; focusing the first beam reflected by the polarization beam splitting/reflective layer and having the first polarization direction at a focal point in the holographic recording layer; and focusing the second beam passing through the cover layer and having the second polarization direction at the focal point in the holographic recording layer so that the first beam and the second beam interfere to form an interference pattern around the focal point so that information is recorded as the interference pattern in the holographic recording layer.

Accordingly, according to aspects of the invention, a holographic information storage medium, and a method of and an apparatus for recording information on and/or reproducing information from the holographic information storage medium, can prevent a signal quality from deteriorating due to noise due to reflected light that is generated when information recorded on the holographic information storage medium is reproduced, thereby improving the signal quality.

Additional aspects and/or advantages of the invention will be set forth in part in the description that follows and, in part, will be obvious from the description, or may be learned by practice of the invention.

### BRIEF DESCRIPTION OF THE DRAWINGS

A better understanding of the invention will become apparent from the following detailed description of exemplary embodiments and the claims when read in connection with the accompanying drawings, all forming a part of the disclosure of the invention. While the following written and illustrated disclosure focuses on disclosing exemplary embodiments of the invention, it should be clearly understood that the same is by way of illustration and example only, and that the invention is not limited thereto. The spirit and scope of the invention are limited only by the terms of the appended claims. The following represents brief descriptions of the drawings, wherein:

FIG. 1 is a cross-sectional view of a holographic information storage medium according to an exemplary embodiment of the invention;

FIG. 2 is a graph of an optical property of a polarization beam splitting/reflective layer according to an exemplary embodiment of the invention;

FIG. 3 shows an optical configuration for emitting a signal beam and a reference beam onto the holographic information storage medium of FIG. 1 according to an exemplary embodiment of the invention;

FIG. 4 is an enlarged image of a portion A in FIG. 3 showing an interference pattern formed by a signal beam and a reference beam;

FIG. 5 shows polarization states of the signal beam and the reference beam incident on the holographic information storage medium of FIG. 1 according to an exemplary embodiment of the invention;

FIG. 6 shows polarization states of a reproduction beam incident on the holographic information storage medium of FIG. 1 according to an exemplary embodiment of the invention;

FIG. 7 is a graph of noise produced by a noise beam Ln3 of FIG. 6 with respect to a distance between an information plane and a polarization beam splitting/reflective layer;

FIGS. 8 through 11 are cross-sectional views of holographic information storage media according to exemplary embodiments of the invention;

FIG. 12 shows an optical configuration of a holographic information recording/reproducing apparatus according to an exemplary embodiment of the invention;

FIG. 13 is a cross-sectional view of a pin hole element according to an exemplary embodiment of the invention; and

FIG. 14 shows a case where a defocused noise beam is blocked by a pin hole element according to an exemplary embodiment of the invention.

### DETAILED DESCRIPTION OF THE INVENTION

Reference will now be made in detail to exemplary embodiments of the invention that are shown in the accompanying drawings, wherein like reference numerals refer to like elements throughout, and the thicknesses of layers and regions may be exaggerated for clarity. The exemplary embodiments are described below in order to explain the invention by referring to the figures.

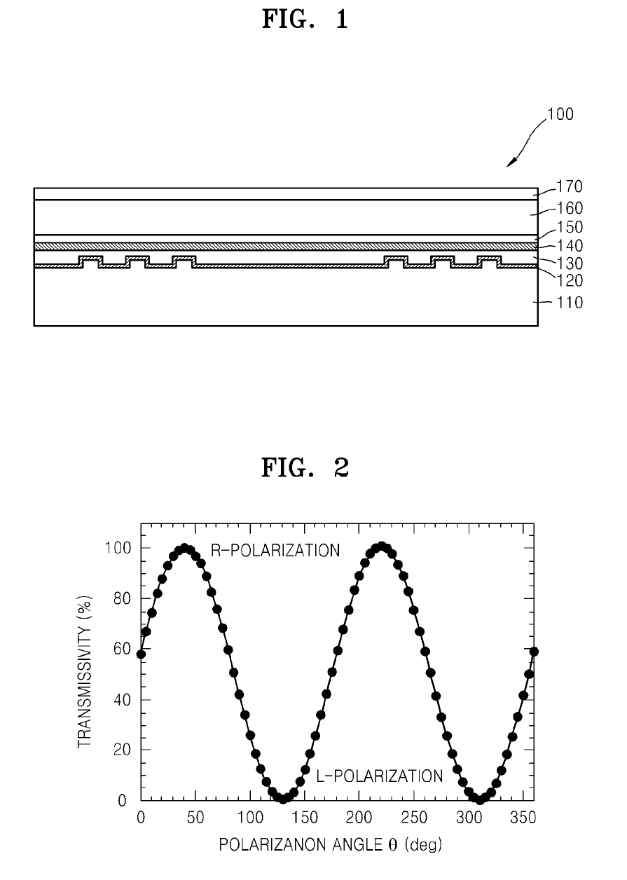

FIG. 1 is a cross-sectional view of a holographic information storage medium 100 according to an exemplary embodiment of the invention.

Referring to FIG. 1, the holographic information storage medium 100 includes a substrate 110, a servo layer 120, a buffer layer 130, a polarization beam splitting/reflective layer 140, a space layer 150, a holographic recording layer 160, and a cover layer 170, which are sequentially stacked in the order shown in FIG. 1.

The substrate 110 is a support provided for maintaining the shape of the holographic information storage medium 100, such as a disk shape, and may be formed of a polycarbonate resin, an acrylic resin, or the like.

The cover layer 170 protects the holographic recording layer 160, and maintains the shape of the holographic information storage medium 100 when the holographic recording layer 160 is not formed of solid material. An anti-reflective layer (not shown) for preventing light from being reflected by a surface of the cover layer 170 may be formed on the cover layer 170.

The holographic recording layer 160 is formed of a photosensitive material, such as a photopolymer or a thermoplastic material, having a refractive index that changes when it absorbs light. In general, the refractive index of a photosensitive material changes in proportion to the intensity of the absorbed light. The photosensitive material may have a nonlinear characteristic in which the photosensitive material has a predetermined threshold in terms of light intensity, and responds only to light having an intensity exceeding the threshold. In order to increase a recording density, a plurality of different interference patterns can be stacked in the holographic recording layer 160 by forming the different interference patterns at different focal point locations in the depth direction of the holographic recording layer 160. Thus, if the material used for forming the holographic recording layer 160 has a nonlinear characteristic, the amplitude of the interference pattern rapidly decreases as the distance from a focal point location increases, and thus dense multilayer recording can be performed.

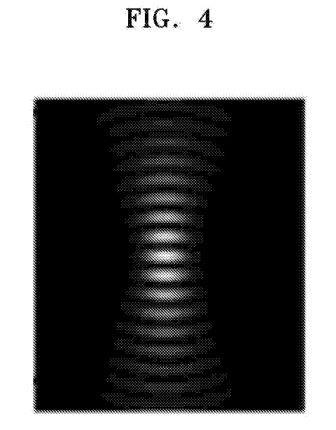

The space layer 150 is a layer for maintaining a distance between the holographic recording layer 160 and the polarization beam splitting/reflective layer 140, and maintains a distance between the polarization beam splitting/reflective layer 140 and a focal point F (refer to FIG. 3) where recording is performed when a signal beam reflected by the polarization beam splitting/reflective layer 140 is focused on the focal point F in the holographic recording layer 160. The thickness of the space layer 150 can vary according to the characteristics of the holographic recording layer 160, and the space layer 150 is formed to have a thickness in the range of 0 to 100 μm. Likewise, by maintaining the distance between the polarization beam splitting/reflective layer 140 and the focal point F, noise due to light reflected by the polarization beam splitting/reflective layer 140 can be reduced when information is reproduced. A detailed relationship between the space layer 150 and the noise reduction is explained below in detail. However, the space layer 150 need not be included in all embodiments of the invention, and other ways of maintaining the distance between the polarization beam splitting/reflective layer 140 and the focal point F may be used. For example, a part of the holographic recording layer 160 that is not used for recording information can replace the space layer 150. The polarization beam splitting/reflective layer 140 is formed of a material that reflects a first circular polarization beam and transmits a second circular polarization beam having respective polarization directions that are orthogonal to each other. Furthermore, the polarization beam splitting/reflective layer 140 reflects the circular polarization beam while maintaining the polarization direction of the reflected first circular polarization beam. A case where the polarization beam splitting/reflective layer 140 reflects a left circular polarization beam and transmits a right circular polarization beam and the reflected left circular polarization beam is maintained in a state of left circular polarization will be described as an example. The polarization beam splitting/reflective layer 140 may be formed of a cholesteric liquid crystal in a liquid crystal film that can be in a liquid crystal state or a hardened state. The cholesteric liquid crystal has a structure in which a director axis of liquid crystal molecules is twisted in a helix. As a result of this structure, the cholesteric liquid crystal reflects a circular polarization beam polarized in the direction of the helix and transmits a circular polarization beam polarized in a direction opposite to the direction of the helix. Thus, the two circular polarization beams having orthogonal polarization directions can be separated, and the state of the reflected circular polarization beam can be maintained in the state of circular polarization.

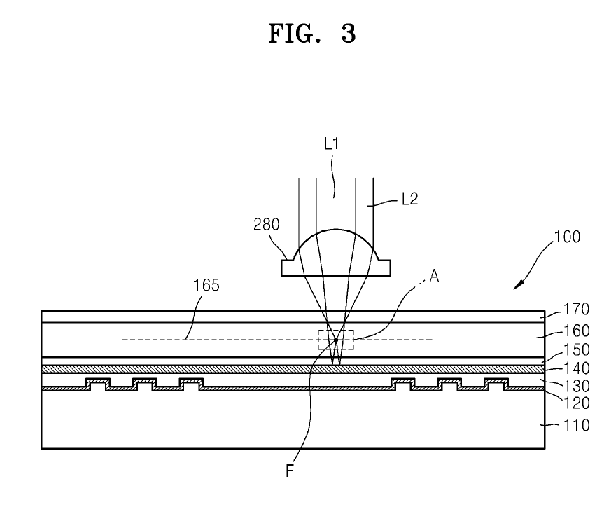

FIG. 2 is a graph of an optical property of the polarization beam splitting/reflective layer 140 according to an exemplary embodiment of the invention. Referring to FIG. 2, a horizontal axis is the polarization angle θ of light transmitted through the polarization beam splitting/reflective layer 140, and a vertical axis is the transmissivity of light incident on the polarization beam splitting/reflective layer 140. It can be seen that an R circular polarization beam is completely transmitted, but an L circular polarization beam is almost completely not transmitted. In the case of the cholesteric liquid crystal constituting the polarization beam splitting/reflective layer 140, the wavelength of the transmitted R circular polarization beam can be controlled according to a helix period. Furthermore, the polarization beam splitting/reflective layer 140 may have a stacked structure in which a plurality of cholesteric liquid crystal layers are stacked so that liquid molecules of the cholesteric liquid crystal layers have different helix periods. In this case, by controlling the helix periods of the stacked cholesteric liquid crystal layers and the number of the stacked cholesteric liquid crystal layers, light having a predetermined wavelength is transmitted or reflected according to the polarization direction of the light, and light having other wavelengths is transmitted. In the current exemplary embodiment, since the servo layer 120 is disposed below the polarization beam splitting/reflective layer 140, a signal beam/reference beam is transmitted/reflected according to the polarization direction of the signal beam/reference beam, and a servo beam is transmitted.

The buffer layer 130 is interposed between the polarization beam splitting/reflective layer 140 and the servo layer 120, and may be formed of a transparent material or a material for absorbing light having a wavelength for recording/reproducing information. The buffer layer 130 is provided to fill in servo patterns formed on the servo layer 120 and representing servo information so that the polarization beam splitting/reflective layer 140 can be formed as a flat layer.

The servo layer 120 is a layer on which the servo information is written, and reflects the servo beam. In the current exemplary embodiment, the wavelength of the servo beam is different than the wavelength of light for recording/reproducing information. In addition, the buffer layer 130, the polarization beam splitting/reflective layer 140, the space layer 150, the holographic recording layer 160, and the cover layer 170, which are disposed above the servo layer 120, are designed so as to transmit the servo beam.

Referring to FIGS. 3 through 5, a method of recording information onto the holographic information storage medium 100 of FIG. 1 according to an exemplary embodiment of the invention is described below.

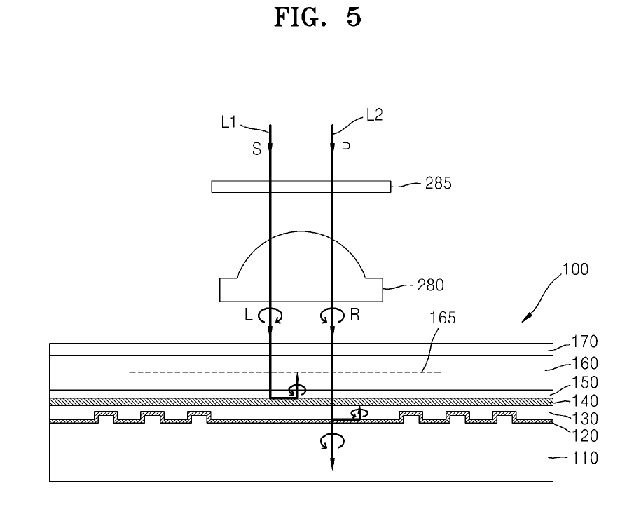

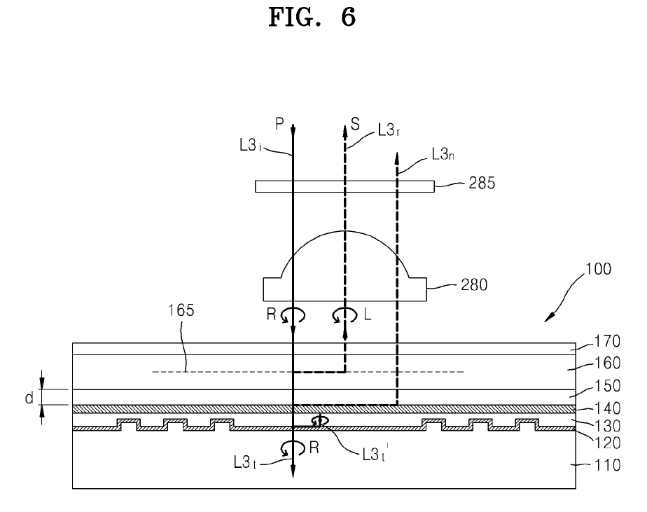

FIG. 3 shows an optical configuration for emitting a signal beam L1 and a reference beam L2 onto the holographic information storage medium 100 of FIG. 1 according to an exemplary embodiment of the invention. FIG. 4 is an enlarged image of a portion A of FIG. 3 showing an interference pattern formed by the signal beam L1 and the reference beam L2. FIG. 5 shows polarization states of the signal beam L1 and the reference beam L2 incident on the holographic information storage medium 100 of FIG. 1 according to an exemplary embodiment of the invention.

Referring to FIG. 3, the signal beam L1 and the reference beam L2 are both incident on the holographic information storage medium 100 via an objective lens 280. The signal beam L1 is reflected by the polarization beam splitting/reflective layer 140 and is focused on the focal point F in the holographic recording layer 160. The reference beam L2 is incident on the cover layer 170 and is focused on the focal point F. Since the light spots of the signal beam L1 and the reference beam L2 overlap at the focal point F, an interference pattern is formed. Since the shape of the interference pattern varies according to the modulated state of the signal beam L1 or the modulated state of the signal beam L1 and the reference beam L2, information can be recorded by using the interference pattern. FIG. 4 is the enlarged image of a portion A including the focal point F of the signal beam L1 and the reference beam L2 shown in FIG. 3 and showing the interference pattern. The interference pattern is recorded along a track on the same plane, thereby forming an information plane 165 of a single layer in the holographic recording layer 160. As the focal point F varies in a depth direction of the holographic recording layer 160, a plurality of the information planes 165 are stacked so that multilayer recording can be performed. The holographic information storage medium 100 according to the current exemplary embodiment uses a micro holography method in which a single bit of information is contained in the interference pattern at each focal point F, but the invention is not limited to such a configuration. For example, a volume holography method can be employed in which an interference pattern is formed in three dimensions when the spots of the signal beam L1 and the reference beam L2 overlap at the focal point F so that a large amount of information is simultaneously recorded.

Referring to FIG. 5, a process of forming an interference pattern in which polarization is a consideration is described below. Referring to FIG. 5, a holographic information recording/reproducing apparatus according to the current exemplary embodiment includes a quarter wave plate 285 and an objective lens 280. A signal beam L1 and a reference beam L2 having different linear polarizations are incident on the quarter wave plate 285. For example, the signal beam L1 is incident on the quarter wave plate 285 in a state of S linear polarization, and the reference beam L2 is incident on the quarter wave plate 285 in a state of P linear polarization. The quarter wave plate 285 is an optical element for changing linear polarization to circular polarization and vice versa. As the signal beam L1 passes through the quarter wave plate 285, the polarization state of the signal beam L1 is changed to left circular polarization L. As the reference beam L2 passes through the quarter wave plate 285, the polarization state of the reference beam L2 is changed to right circular polarization R. The signal beam L1 having the left circular polarization L is reflected by the polarization beam splitting/reflective layer 140, which maintains the left circular polarization L in the reflected signal beam L1. The reflected signal beam L1 having the left circular polarization L is focused on the information plane 165. The reference beam L2 having the right circular polarization R is focused on the information plane 165, and then passes through the polarization beam splitting/reflective layer 140. Since the reflected signal beam L1 and the reference beam L2 that meet on the information plane 165 are traveling in opposite directions and have opposite circular polarization directions, the electric field vector of the reflected signal beam L1 and the electric field vector of the reference beam L2 rotate in the same direction. Thus, an interference pattern is generated on the information plane 165, and the interference pattern causes the recording of information in the holographic recording layer 160 formed of a photosensitive material.

The reference beam L2 having the right circular polarization R that passes through the polarization beam splitting/reflective layer 140 may be reflected by the servo layer 120 or the like. However, since the reference beam L2 reflected by the servo layer 120 or the like has only its traveling direction changed while the rotational direction of its electric field vector remains unchanged, the reference beam L2 reflected by the servo layer 120 or the like is in a state of left circular polarization L. Thus, the reference beam L2 cannot pass back through the polarization beam splitting/reflective layer 140.

In the above, description, the beam L1 has been described as a signal beam and the beam L2 has been described as a reference beam. However, the beam L1 may be the reference beam, and the beam L2 may be the signal beam.

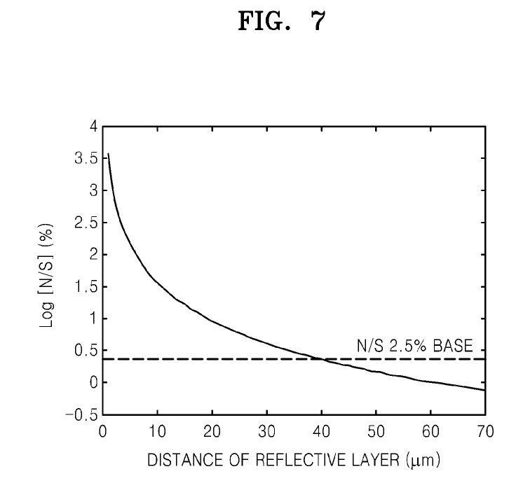

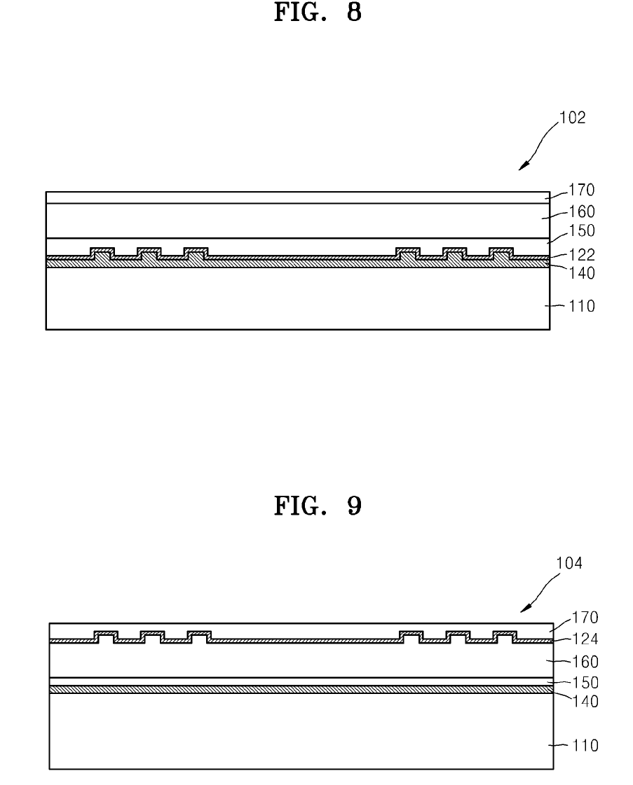

Referring to FIGS. 6 and 7, a method of reproducing information recorded on the holographic information storage medium 100 of FIG. 1 according to an exemplary embodiment of the invention is described below.

FIG. 6 shows polarization states of a reproduction beam incident on the holographic information storage medium 100 of FIG. 1 according to an exemplary embodiment of the invention. FIG. 7 is a graph of noise produced by the noise beam L3n of FIG. 6 with respect to the distance between the information plane 165 and the polarization beam splitting/reflective layer 140, which is denoted by “distance of reflective layer” in FIG. 7.

Referring to FIG. 6, a reproduction beam having the same polarization direction as that of a reference beam is emitted to the holographic information storage medium 100 in order to reproduce information. That is, an incident reproduction beam L3i having P polarization passes through the quarter wave plate 285 and is changed to a state of right circular polarization R. Then, the incident reproduction beam L3i having the right circular polarization R passes through the objective lens 280 and is incident on the holographic information storage medium 100. With respect to the information plane 165, a beam incident on the information plane 165 is referred to as the incident reproduction beam L3i, a beam reflected by the information plane 165 is referred to as a reflective reproduction beam L3r, and a beam transmitted through the information plane 165 is referred to as a transmissive reproduction beam L3t. Part of the incident reproduction beam L3i having the right circular polarization R is diffracted, that is, reflected, by the information plane 165 where information is recorded by an interference pattern, and travels back to the objective lens 280 as the reflective reproduction beam L3r, and part of the incident reproduction beam L3i having the right circular polarization R is transmitted through the information plane 165 and travels towards the polarization beam splitting/reflective layer 140. Since the reflective reproduction beam L3r reflected by the information plane 165 has only its traveling direction changed while the rotational direction of its electric field vector remains unchanged, the reflective reproduction beam L3r is in a state of left circular polarization L. Since the transmissive reproduction beam L3t transmitted through the information plane 165 from the incident reproduction beam L3i having the right circular polarization R is in a state of right circular polarization R, the transmissive reproduction beam L3t passes through the polarization beam splitting/reflective layer 140. The transmissive reproduction beam L3t can be reflected by the servo layer 120 or the like as a reflected transmissive reproduction beam L3t′. However, since the reflected transmissive reproduction beam L3t′ has only its traveling direction changed while the rotational direction of its electric field vector remains unchanged, the reflected transmissive reproduction beam L3t′ reflected by the servo layer 120 or the like is in a state of left circular polarization L. Thus, the reflected transmissive reproduction beam L3t′ cannot pass back through the polarization beam splitting/reflective layer 140. If the reflected transmissive reproduction beam L3t′ passes through the information plane 165 to be incident back on the objective lens 280, the reflected transmissive reproduction beam L3t′ may contribute to a noise beam L3n of reflected light with respect to a reproduction signal contained in the reflective reproduction beam L3r. However, according to the current exemplary embodiment, since the reflected transmissive reproduction beam L3t′ cannot pass back through the polarization beam splitting/reflective layer 140, the noise beam L3n due to reflected light can be reduced, thereby enhancing signal quality. A conventional servo layer is designed so that it will not reflect the transmissive reproduction beam L3t in order to reduce the noise beam L3n. However, according to the invention, even if the servo layer 120 or the like reflects the transmissive reproduction beam L3t as the reflected transmissive reproduction beam L3t′, the reflected transmissive reproduction beam L3t′ cannot pass back through the polarization beam splitting/reflective layer 140. Thus, since the performance required for the servo layer 120 is reduced, it is easier to manufacture the holographic information storage medium 100 according to the current exemplary embodiment than in the case where the conventional servo layer is used.

In the above description, it has been assumed that the transmissive reproduction beam L3t having the right circular polarization R passes through the polarization beam splitting/reflective layer 140 without being reflected by the polarization beam splitting/reflective layer 140. In reality, however, part of the transmissive reproduction beam L3t having the right circular polarization R may be reflected by the polarization beam splitting/reflective layer 140. In this case, since only a very small percentage of the incident reproduction beam L3i having the right circular polarization R is by the information plane 165 as the reflective reproduction beam L3r, a component of the noise beam L3n attributable to the transmissive reproduction beam L3t that is partially reflected by the polarization beam splitting/reflective layer 140 can cause problems. However, the component of the noise beam L3n attributable to the transmissive reproduction beam L3t that is partially reflected by the polarization beam splitting/reflective layer 140 can be reduced by sufficiently increasing the distance between the information plane 165 where information is recorded and the polarization beam splitting/reflective layer 140.

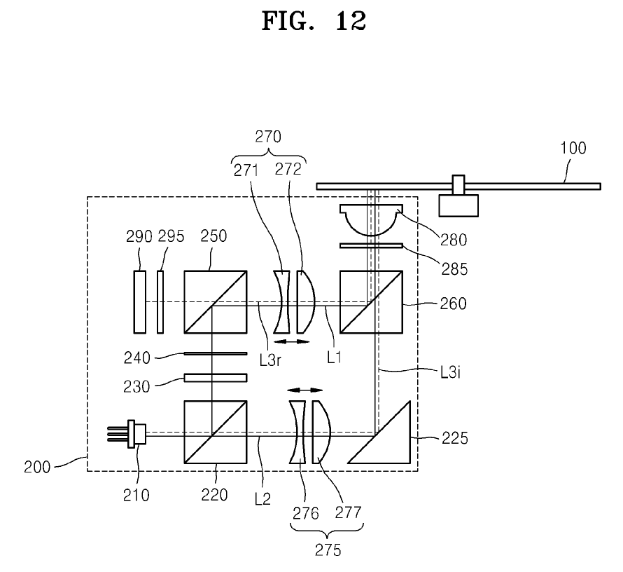

FIG. 7 is a graph of noise produced by the noise beam L3n of FIG. 6 with respect to the distance between the information plane 165 and the polarization beam splitting/reflective layer 140 that was obtained by performing a simulation. The “distance of reflective layer” in FIG. 7 is the distance between the polarization beam splitting/reflective layer 140 and the information plane 165 where information is actually recorded. In the simulation, the incident reproduction beam L3i was assumed to be reflected by the information plane 165 at a reflectivity of about 0.0135% to form the reflective reproduction beam L3r, and the transmissive reproduction beam L3t having the right circular polarization R was assumed to be reflected by the polarization beam splitting/reflective layer 140 at a noise reflectivity of about 1%. As the distance between the information plane 165 and the polarization beam splitting/reflective layer 140 increases, the transmissive reproduction beam L3t, which is focused on the information plane 165, becomes increasingly defocused on the polarization beam splitting/reflective layer 140. Thus, the intensity of the component of the noise beam L3n attributable to the portion of the transmissive reproduction beam L3t that is reflected by the polarization beam splitting/reflective layer 140 is reduced. Referring to FIG. 7, when the distance between the information plane 165 and the polarization beam splitting/reflective layer 140 is 40 μm or more, it can be seen that noise-to-signal (N/S) ratio is less than 2.5%. Under the conditions of the simulation, the thickness “d” of the space layer 150 may be at least 40 μm in order to generate a N/S ratio less than 2.5%. Preferably, the thickness “d” of the space layer 150 may be 50 μm or more so as to generate a N/S ratio of 1.5% or less. However, the thickness “d” of the space layer 150 may vary according to optical design parameters, such as the reflectivity of the information plane 165, the noise reflectivity of the polarization beam splitting/reflective layer 140, and the like. Furthermore, as described above, by forming the holographic recording layer 160 to have a sufficient thickness to replace the space layer 150 while still maintaining a distance between the information plane 165 where information is recorded and the polarization beam splitting/reflective layer 140 of 40 μm or more, the component of the noise beam L3n attributable to the portion of the transmissive reproduction beam L3t that is reflected by the polarization beam splitting/reflective layer 140 can be reduced. In addition, the holographic information recording/reproducing apparatus according to an exemplary embodiment of the invention includes a pin hole element 295 (refer to FIG. 12) disposed in front of a photodetector 290, thereby limiting the detection of defocused light. Thus, the component of the noise beam L3n attributable to the portion of the transmissive reproduction beam L3t that is reflected by the polarization beam splitting/reflective layer 140 can be further reduced or eliminated.

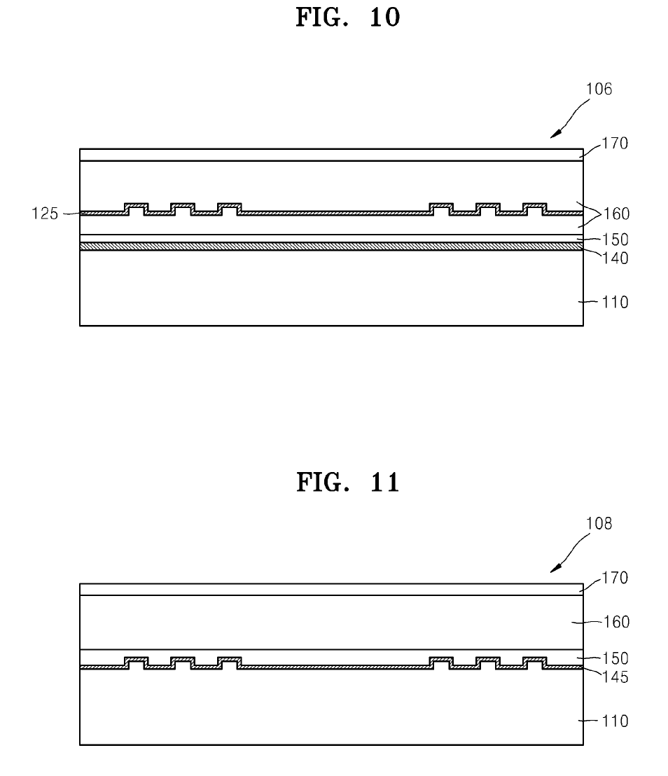

In the above-described exemplary embodiment, the servo layer 120 is interposed between the substrate 110 and the polarization beam splitting/reflective layer 140, but the invention is not limited to such a structure. FIGS. 8 through 11 are cross-sectional views of holographic information storage media 102, 104 106, and 108 in which the servo layers 122, 124, 125, and 145 are disposed at different locations according to other exemplary embodiments of the invention.

Referring to FIG. 8, the holographic information storage medium 102 may have a structure in which the servo layer 122 is interposed between the polarization beam splitting/reflective layer 140 and the space layer 150. The servo layer 122 is formed of a material capable of transmitting beams for recording/reproducing information, that is, a signal beam, a reference beam, and a reproduction beam. Like in the case of the holographic information storage medium 100 of FIG. 1, by interposing the polarization beam splitting/reflective layer 140 between the holographic recording layer 160 and the substrate 110, the transmissive reproduction beam that passes through the holographic recording layer 160 can be prevented from being reflected back to the objective lens to generate noise, thereby eliminating that source of noise. The elements in the exemplary embodiment of FIG. 8 except for the servo layer 122 are substantially the same as those of the holographic information storage medium 100 described with reference to FIGS. 1 through 6, and thus detailed descriptions thereof will be omitted.

Referring to FIG. 9, the holographic information storage medium 104 has a structure in which the servo layer 124 is interposed between the holographic recording layer 160 and the cover layer 170. The servo layer 124 is formed of a material capable of transmitting beams for recording/reproducing information, that is, a signal beam, a reference beam, and a reproduction beam. Like in the case of the holographic information storage medium 100 of FIG. 1, by interposing the polarization beam splitting/reflective layer 140 between the holographic recording layer 160 and the substrate 110, the transmissive reproduction beam that passes through the holographic recording layer 160 can be prevented from being reflected back to the objective lens to generate noise, thereby eliminating that source of noise. The elements in the exemplary embodiment of FIG. 9 except for the servo layer 124 are substantially the same as those of the holographic information storage medium 100 described with reference to FIGS. 1 through 6, and thus detailed descriptions thereof will be omitted.

Referring to FIG. 10, the holographic information storage medium 106 has a structure in which the servo layer 125 is disposed inside the holographic recording layer 160. The servo layer 125 is formed of a material capable of transmitting beams for recording/reproducing information, that is, a signal beam, a reference beam, and a reproduction beam. Like in the case of the holographic information storage medium 100 of FIG. 1, by interposing the polarization beam splitting/reflective layer 140 between the holographic recording layer 160 and the substrate 110, the transmissive reproduction beam that passes through the holographic recording layer 160 can be prevented from being reflected back to the objective lens, thereby eliminating that source of noise. The elements in the exemplary embodiment of FIG. 10 except for the servo layer 125 are substantially the same as those of the holographic information storage medium 100 described with reference to FIGS. 1 through 6, and thus detailed descriptions thereof will be omitted.

In the above-described embodiments, the wavelength of the servo beam is different from the wavelength of a beam for recording/reproducing information, but the invention is not limited to such an arrangement. Referring to FIG. 11, the holographic information storage medium 108 does not have a separate servo layer, but uses the polarization beam splitting/reflective layer 145 as a servo layer. A separate beam that is different from the beam for recording/reproducing information can be used as the servo beam, but the invention is not limited so such an arrangement. For example, the beam for recording/reproducing information can also be used as the servo beam. When a separate beam that is different from the beam for recording/reproducing information is used as the servo beam, the polarization beam splitting/reflective layer 145 is designed to reflect the servo beam. When the beam for recording/reproducing information is also used as the servo beam, the reflected reproduction beam is used as the servo beam.

FIG. 12 shows an optical configuration of a holographic information recording/reproducing apparatus according to an embodiment of the invention.

Referring to FIG. 12, the holographic information recording/reproducing apparatus according to the current exemplary embodiment is an apparatus for recording information on and reproducing information from the holographic information storage medium 100 of FIG. 1, and includes an optical pickup 200 to emit a signal beam L1 and a reference beam L2 having respective circular polarization directions that are orthogonal to each other, and a circuit unit (not shown) to control the driving of the optical pickup 200 and the processing of signals.

The optical pickup 200 includes a light source 210, a first beam splitter 220, a half wave plate 230, a shutter 240, a second beam splitter 250, a third beam splitter 260, a mirror 225, a quarter wave plate 285, an objective lens 280, and a photodetector 290. The optical pickup 200 may further include focal point control units 270 and 275 to vary the focal point locations of the signal beam L1 and the reference beam L2, respectively, in order to record/reproduce information in multiple layers. In addition, the optical pickup 200 may further include a pin hole element 295 blocking a defocused noise beam from being incident on the photodetector 290. Also, the optical pickup 200 may further include a servo optical system (not shown) for performing servo control.

The light source 210 may emit only light having P polarization and may include, for example, a semiconductor laser diode emitting blue light. The polarization direction of the emitted light is described as being P polarization for convenience of description, but the invention is not limited to P polarization. Alternatively, the light source 210 may emit unpolarized light, and light having a predetermined linear polarization can be selected from the unpolarized light using a separate polarization plate (not shown). The light source 210 may be also used as a servo light source, or a separate servo light source may be employed. When a separate servo light source is employed, the wavelength of a servo beam may be different from a wavelength of light emitted from the light source 210. The first, second, and third beam splitters 220, 250, and 260 are examples of an optical path splitting unit. Each of the first and second beam splitters 220 and 250 functions as a half mirror, splitting light passing through the first and second beam splitters 220 and 250 into light traveling on two optical paths. The light emitted from the light source 210 having P polarization is split by the first beam splitter 220 into the signal beam L1 and the reference beam L2 each having P polarization. The signal beam L1 having P polarization split by the first beam splitter 220 is converted by the half wave plate 230 into light having S polarization, and passes through the second and third beam splitters 250 and 260. The shutter 240 blocks light in accordance with an electrical signal, and is disposed on an optical path of the signal beam L1. The shutter 240 passes the signal beam L1 in accordance with an electrical signal indicative of information to be recorded when information is being recorded, and blocks a reflective reproduction beam L3r in accordance with an electrical signal indicating that the reflective reproduction beam L3r is to be blocked when information is being reproduced. The optical path of the reference beam L2 having P polarization split by the first beam splitter 220 is changed by the mirror 225 so that the reference beam L2 travels towards the third beam splitter 260. The third beam splitter 260 is a polarization beam splitter that reflects the signal beam L1 having S polarization and transmits the reference beam L2 having P polarization. Thus, the signal beam L1 and the reference beam L2 are incident on the third beam splitter 260 along different optical paths. Then, the optical paths are combined in the third beam splitter 260 so that the signal beam L1 having S polarization and the reference beam having P polarization travel towards the quarter wave plate 285.

The S polarization of the signal beam L1 incident on the quarter wave plate 285 is converted into left circular polarization L. The P polarization of the reference beam L2 incident on the quarter wave plate 285 is converted into right circular polarization. The signal beam L1 and the reference beam L2 having the converted polarization directions that are orthogonal to each other are incident on the holographic information storage medium 100 via the objective lens 280, thereby recording holographic information as described with reference to FIGS. 3 through 5.

The focal point control units 270 and 275 may include beam expanders, such as relay lens groups 271, 272, 276, and 277. The focal point control units 270 and 275 are designed so that at least one lens of the relay lens groups 271, 272, 276, and 277 can be moved in the direction of the optical path as indicated by the two-headed arrows in FIG. 12 under the control of a driving unit (not shown). By moving the at least one lens of the relay lens groups 271, 272, 276, and 277 in the direction of the optical path, the focal point control units 270 and 275 can vary focal points of the signal beam L1 and the reference beam L2 in the holographic information storage medium 100. The focal point control units 270 and 275 enable information to be recorded in multiple layers in the holographic information storage medium 100. That is, when the signal beam L1 and the reference beam L2 are focused on the focal point F (refer to FIG. 3) in the holographic information storage medium 100, the information plane 165 is formed. As the focal point locations of the signal beam L1 and the reference beam L2 are varied by the focal point control units 270 and 275, a plurality of information planes 165 (not shown) are formed in a depth direction of the holographic information storage medium 100. Thus, recording can be performed in multiple layers. In the current exemplary embodiment, the focal point control units 270 and 275 include the beam expanders including, for example, the relay lens groups 271, 272, 276, and 277, but the invention is not limited to such a configuration. For example, the focal point control units 270 and 275 can be implemented using a liquid crystal lens. When a voltage is applied to the liquid crystal lens, a beam having a predetermined polarization is refracted due to the orientation of the liquid crystal of the liquid crystal lens. The structure of a liquid crystal lens is well known to one of ordinary skill in the art, and thus its description will be omitted. Such liquid crystal lenses can be disposed on the respective optical paths of the signal beam L1 and the reference beam L2 in place of the relay lens groups 271, 272, 276, and 277, and a voltage can be applied to the liquid crystal lenses. Thus, the focal points of the signal beam L1 and the reference beam L2 can be varied.

When information is to be reproduced, an incident reproduction beam L3i emitted from the light source 210 passes through the first beam splitter 220, the mirror 225, the third beam splitter 260, the quarter wave plate 285, and the objective lens 280 and is incident on the holographic information storage medium 100. The incident reproduction beam L3i is reflected by the information plane 165 (refer to FIG. 6) where information is recorded in the form of an interference pattern in the holographic information storage medium 100, and is incident back on the objective lens 280. Since the incident reproduction beam L3i travels along the same optical path as the reference beam L2, the incident reproduction beam L3i is incident on the holographic information storage medium 100 in a state of right circular polarization. The reflective reproduction beam L3r reflected by the information plane 165 is converted into a left circular polarization beam and is incident back on the objective lens 280. The reflective reproduction beam L3r having a left circular polarization passes through the quarter wave plate 285 where it is converted into an S polarization beam, is reflected by the third beam splitter 260, and passes through the second beam splitter 250 to be detected by the photodetector 290. Part of the reflective reproduction beam L3r may be reflected by the second beam splitter 250, but such a part of the reflective reproduction beam L3r reflected by the second beam splitter 250 is blocked by the shutter 240, which is closed when information is being reproduced. When information is recorded in multiple layers in the holographic recording layer 160 (refer to FIG. 6), by varying the focal point location of the incident reproduction beam L3i using the focal point control unit 275 for varying a focal point location of the reference beam L2, the focal point location of the incident reproduction beam L3i can be set on the information plane 165 where information is to be read.

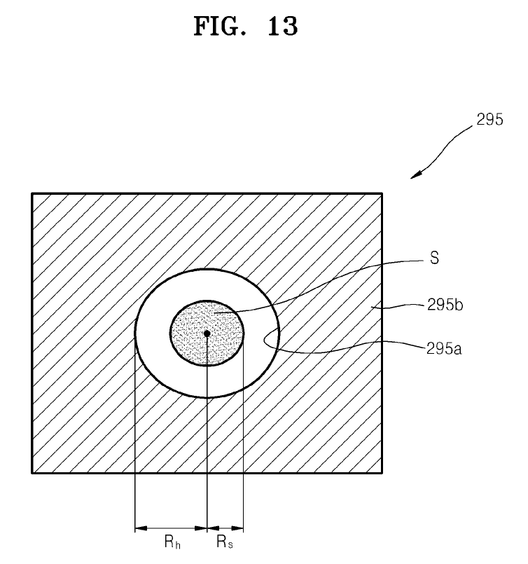

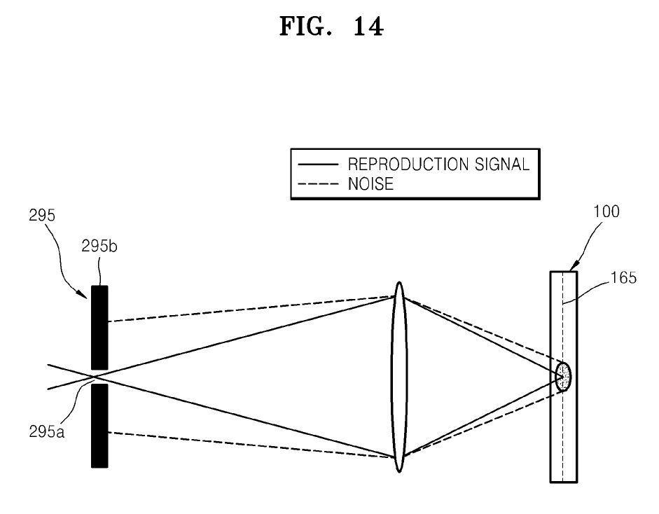

The pin hole element 295 blocks light reflected by any element except for the information plane 165 where information is to be read. The pin hole element 295 includes a predetermined aperture as shown in FIG. 13, that is, a pin hole 295a and a blocking layer 295b blocking light, and is disposed in front of the photodetector 290. The radius Rh of the pin hole 295a may be greater than the radius Rs of a beam spot S. For example, the radius Rh may be twice the radius Rs of the beam spot S. The pin hole element 295 blocks a defocused beam. Referring to FIG. 14, when the focal point location of an incident reproduction beam is set on the information plane 165 where information is to be read, and the pin hole 295a of the pin hole element 295 is disposed at a focal point location where the reflective reproduction beam reflected by the information plane 165 in the holographic information storage medium 100 is focused in the optical pickup 200 (refer to FIG. 12), light reflected by any element except the information plane 165, for example, the defocused noise beam L3n (refer to FIG. 6) that is produced when the transmissive reproduction beam L3t is partially reflected by the polarization beam splitting/reflective layer 140, is almost completely blocked by the blocking layer 295b. Accordingly, the noise attributable to the noise beam L3n reflected by the polarization beam splitting/reflective layer 140 can be reduced or eliminated by providing the pin hole element 295 in addition to the space layer 150 as described above.

As described with reference to FIG. 6, when information is reproduced, the transmissive reproduction beam L3t passing through the holographic recording layer 160 from the incident reproduction beam L3i for reproducing information is transmitted by the polarization beam splitting/reflective layer 140, and the reflected transmissive reproduction beam L3t′ reflected by the servo layer 120 or the like is blocked by the polarization beam splitting/reflective layer 140. Furthermore, even though a portion of the transmissive reproduction beam L3t is reflected by the polarization beam splitting/reflective layer 140, noise can be reduced or eliminated by providing the space layer 150 of the holographic information storage medium 100 and/or the pin hole element 295 of the holographic information recording/reproducing apparatus.

A holographic information storage medium, and a method and apparatus for recording/reproducing holographic information using the holographic information storage medium, have been particularly shown and described with reference to exemplary embodiments of the invention. As can be seen from these exemplary embodiments, by interposing a polarization beam splitting/reflective layer, which selectively reflects and transmits circular polarization beams having respective orthogonal polarization directions, between a holographic recording layer and a substrate to reduce or eliminate noise due to reflected light, a transmissive reproduction beam that is transmitted through the holographic recording layer is prevented from being reflected back to an objective lens as a noise beam, thereby reducing or eliminating the noise due to reflected light.

While there have been shown and described what are considered to be exemplary embodiments of the invention, it will be understood by those skilled in the art and as technology develops that various changes and modifications may be made and equivalents may be substituted for elements thereof without departing from the true scope of the invention. Many modifications, permutations, additions, and sub-combinations may be made to adapt the teachings of the invention to a particular situation without departing from the scope thereof. Accordingly, it is therefore intended that the invention not be limited to the various exemplary embodiments disclosed, but that the invention includes all embodiments falling within the scope of the claims and their equivalents.

1. A holographic information storage medium comprising:
a substrate;
a cover layer to receive a first circular polarization beam having a first polarization direction and a second circular polarization beam having a second polarization direction orthogonal to the first polarization direction;
a polarization beam splitting/reflective layer disposed between the substrate and the cover layer to reflect the first beam while maintaining the first polarization direction of the first beam, and to transmit the second beam; and
a holographic recording layer disposed between the polarization beam splitting/reflective layer and the cover layer to record information as an interference pattern formed in the holographic recording layer by the first beam reflected by the polarization beam splitting/reflective layer and the second beam received by the cover layer.

2. The medium of claim 1, wherein the polarization beam splitting/reflective layer comprises a cholesteric liquid crystal material.

3. The medium of claim 1, wherein the polarization beam splitting/reflective layer comprises a cholesteric liquid crystal film that is in a liquid crystal state or a hardened state.

4. The medium of claim 1, wherein the polarization beam splitting/reflective layer comprises a single cholesteric liquid crystal layer or a plurality of cholesteric liquid crystal layers comprising cholesteric liquid crystal molecules having helix periods that are different for each of the plurality of cholesteric liquid crystal layers.

5. The medium of claim 1, wherein the holographic recording layer comprises a photopolymer or a thermoplastic resin.

6. The medium of claim 1, further comprising a servo layer disposed between the substrate and the polarization beam splitting/reflective layer, or between the polarization beam splitting/reflective layer and the holographic recording layer, or inside the holographic recording layer, or between the holographic recording layer and the cover layer.

7. The medium of claim 1, wherein the polarization beam splitting/reflective layer has servo information recorded thereon.

8. The medium of claim 1, further comprising a space layer disposed between the polarization beam splitting/reflective layer and the holographic recording layer.

9. The medium of claim 8, wherein a thickness of the space layer is equal to or greater than 40 μm.

10. The medium of claim 1, wherein a distance between the polarization beam splitting/reflective layer and any information plane in the holographic recording layer on which information is written is equal to or greater than 40 μm.

11. The medium of claim 1, wherein:
the information is recorded on a plurality of information planes arranged in a depth direction of the holographic recording layer; and
the first beam reflected by the polarization beam splitting/reflective layer and the second beam received by the cover layer each have a plurality of focal point locations arranged in the depth direction of the holographic recording layer and respectively coinciding with the plurality of information planes.

12. The medium of claim 1, wherein the information recorded as the interference pattern is recorded in units of a single bit.

13. A holographic information recording/reproducing apparatus for recording information on and/or reproducing information from a holographic information storage medium, the holographic information storage medium comprising a substrate, a cover layer, a polarization beam splitting/reflective layer disposed between the substrate and the cover layer to reflect a first circular polarization beam having a first polarization direction while maintaining the first polarization direction of the first beam, and to transmit a second circular polarization beam having a second polarization direction orthogonal to the first polarization direction, and a holographic recording layer disposed between the polarization beam splitting/reflective layer and the cover layer, the apparatus comprising:
an optical pickup to generate the first circular polarization beam having the first polarization direction and the second circular polarization beam having the second polarization orthogonal to the first circular polarization direction, and to emit the first beam and the second beam to be incident on the cover layer of the holographic information storage medium so that:
the first beam is reflected by the polarization beam splitting/reflective layer;
the first beam reflected by the polarization beam splitting/reflective layer and the second beam incident on the cover layer form an interference pattern at a focal point in the holographic recording layer; and
the holographic recording layer records information as the interference pattern at the focal point.

14. The apparatus of claim 13, wherein in order to reproduce the information recorded as the interference pattern in the holographic recording layer, the optical pickup emits the second beam having the second polarization direction to be incident on the cover layer of the holographic information storage medium so that:
the second beam having the second polarization direction is partially reflected by the interference pattern in the holographic recording layer to form a reflective reproduction beam having the first polarization direction, and is partially transmitted by the interference pattern in the holographic recording layer to form a transmissive reproduction beam having the second polarization direction;
the reflective reproduction beam is incident on the optical pickup;
the transmissive reproduction beam passes through the polarization beam splitting/reflective layer; and
the polarization beam splitting/reflective layer blocks any reflected light generated by reflection of the transmissive reproduction beam after the transmissive reproduction beam has passed through the polarization beam splitting/reflective layer from being incident on the optical pickup.

15. The apparatus of claim 13, wherein the optical pickup comprises a focal point varying unit to vary a position of the focal point in a depth direction of the holographic recording layer.

16. The apparatus of claim 15, wherein the focal point varying unit comprises a beam expander or a liquid crystal lens.

17. The apparatus of claim 13, wherein the optical pickup comprises a pin hole element to block light reflected from any point except the focal point.

18. The apparatus of claim 13, wherein the information recorded as the interference pattern at the focal point is recorded in units of a single bit.

19. A holographic information recording/reproducing apparatus for recording information on and/or reproducing information from a holographic information storage medium, the holographic information storage medium comprising a substrate, a cover layer, a polarization beam splitting/reflective layer disposed between the substrate and the cover layer to reflect a first circular polarization beam having a first polarization direction while maintaining the first polarization direction of the first beam, and to transmit a second circular polarization beam having a second polarization direction orthogonal to the first polarization direction, and a holographic recording layer disposed between the polarization beam splitting/reflective layer and the cover layer to record information as an interference pattern formed at a focal point in the holographic recording layer by the first beam reflected by the polarization beam splitting/reflective layer and the second beam, the apparatus comprising:
an optical pickup to generate the second circular polarization beam having the second polarization direction orthogonal to the first polarization direction, and to emit the second beam to be incident on the cover layer of the holographic information medium so that:
the second beam having the second polarization direction is partially reflected at the focal point by the interference pattern in the holographic recording layer to form a reflective beam having the first polarization direction, and is partially transmitted by the interference pattern in the holographic recording layer to form a transmissive beam having the second polarization direction;
the reflective beam is incident on the optical pickup;
the transmissive beam passes through the polarization beam splitting/reflective layer; and
the polarization beam splitting/reflective layer blocks any reflected light generated by reflection of the transmissive beam after the transmissive beam has passed through the polarization beam splitting/reflective layer from being incident on the optical pickup.

20. A method of recording information on and/or reproducing information from a holographic information storage medium, the holographic information storage medium comprising a substrate, a cover layer, a polarization beam splitting/reflective layer disposed between the substrate and the cover layer to reflect a first circular polarization beam having a first polarization direction while maintaining the first polarization direction of the first beam, and to transmit a second circular polarization beam having a second polarization direction orthogonal to the first polarization direction, and a holographic recording layer disposed between the polarization beam splitting/reflective layer and the cover layer, the method comprising:
generating the first circular polarization beam having the first polarization direction and the second circular polarization beam having the second polarization direction orthogonal to the first polarization direction;
emitting the first beam and the second beam onto the cover layer of the holographic information storage medium so that the first beam and the second beam pass through the cover layer;
focusing the first beam reflected by the polarization beam splitting/reflective layer and having the first polarization direction at a focal point in the holographic recording layer; and
focusing the second beam passing through the cover layer and having the second polarization direction at the focal point in the holographic recording layer so that the first beam and the second beam interfere to form an interference pattern around the focal point so that information is recorded as the interference pattern in the holographic recording layer.

21. The method of claim 20, wherein the generating of the first circular polarization beam having the first polarization direction and the second circular polarization beam having the second polarization direction orthogonal to the first polarization direction comprises:
emitting linear polarization light having only a first linear polarization direction from a light source;
generating a first linear polarization beam having the first polarization direction from the linear polarization light;
generating a second linear polarization beam having a second polarization direction orthogonal to the first polarization direction from the linear polarization light;
generating the first circular polarization beam from the first linear polarization beam and generating the second circular polarization beam from the second linear polarization beam, or generating the first circular polarization beam from the second linear polarization beam and generating the second circular polarization beam from the first linear polarization beam.

22. The method of claim 20, further comprising reproducing the information recorded as the interference pattern in the holographic recording layer;
wherein the reproducing of the information recorded as the interference pattern in the holographic recording layer comprises:
emitting the second beam having the second polarization direction to be incident on the cover layer of the holographic information recording layer so that the second beam passes through the cover layer and is at least partially reflected by the interference pattern in the holographic recording layer to form a reflective reproduction beam; and
detecting the information recorded as the interference pattern in the holographic recording layer from the reflective reproduction beam.

23. The method of claim 20, wherein the information recorded as the interference pattern is recorded in units of a single bit.

24. The method of claim 20, further comprising varying a position of the focal point in a depth direction of the holographic recording layer to record information on a plurality of information planes arranged in the depth direction of the holographic recording layer.
